(19) United States
(12) Patent Application Publication
(10) Pub. No.: US 2006/0059011 A1
(43) Pub. Date: Mar. 16, 2006

(54) Systems for automated proposal generation

(76) Inventors: Karen Ulreich, Fairfield, OH (US); Benjamin Flick, Cincinnati, OH (US); Ronald Schierberg, Edgewood, KY (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/226,730

(22) Filed: Sep. 14, 2005

Related U.S. Application Data
(60) Provisional application No. 60/609,955, filed on Sep. 15, 2004.

(51) Int. Cl. G06Q 99/00

(52) U.S. Cl. 705/1

(57) ABSTRACT

The present application describes certain exemplary embodiments of systems and methods for automated proposal generation, tracking, and/or management. Certain exemplary embodiments of the systems and/or methods can be viewed as web-based software tools adapted for use by sales entities and/or related support personnel, such as Application Engineers (AEs), that seek to provide professional and/or technical sales proposals, such as sales proposals for above-NEMA squirrel cage motors. Certain exemplary embodiments of the software tools can provide automated analysis of customer inputs, needs, specifications, and/or requirements. Certain exemplary embodiments of the software tools can automatically provide cost analysis, electrical data, performance curves, and/or dimensional drawings, etc.

### CROSS-REFERENCES TO RELATED APPLICATIONS

This application claims priority to, and incorporates by reference herein in its entirety, pending U.S. Provisional Patent Application Ser. No. 60/609,955 (Attorney Docket No. 2004P15809US), filed 15 Sep. 2004.

### BACKGROUND

Certain entities provide sales proposals based on customer inputs, needs, specifications, and/or requirements. For entities that sell relatively complex products and/or services, generating, tracking, and/or managing such proposals can prove relatively complex and/or costly.

### SUMMARY

Hence, the present application describes certain exemplary embodiments of systems and methods for automated proposal generation, tracking, and/or management. Certain exemplary embodiments of the systems and/or methods can be viewed as web-based software tools adapted for use by sales entities and/or related support personnel, such as Application Engineers (AEs), that seek to provide professional and/or technical sales proposals, such as sales proposals for above-NEMA squirrel cage motors. Certain exemplary embodiments of the software tools can provide automated analysis of customer inputs, needs, specifications, and/or requirements. Certain exemplary embodiments of the software tools can automatically provide cost analysis, electrical data, performance curves, and/or dimensional drawings, etc.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a flowchart of an exemplary embodiment of a method 1000;

FIG. 2 is a screen shot of an exemplary embodiment of an interface 2000;

FIG. 3 is a screen shot of an exemplary embodiment of an interface 3000;

FIG. 4 is a screen shot of an exemplary embodiment of an interface 4000;

FIG. 5 is a screen shot of an exemplary embodiment of an interface 5000;

FIG. 6 is a screen shot of an exemplary embodiment of an interface 6000;

FIG. 7 is a screen shot of an exemplary embodiment of an interface 7000;

FIG. 8 is a screen shot of an exemplary embodiment of an interface 8000;

FIG. 9 is a screen shot of an exemplary embodiment of an interface 9000;

FIG. 10 is a screen shot of an exemplary embodiment of an interface 10000;

FIG. 11 is a screen shot of an exemplary embodiment of an interface 11000;

FIG. 12 is a screen shot of an exemplary embodiment of an interface 12000;

FIG. 13 is a screen shot of an exemplary embodiment of an interface 13000;

FIG. 14 is a screen shot of an exemplary embodiment of an interface 14000;

FIG. 15 is a screen shot of an exemplary embodiment of an interface 15000;

FIG. 16 is a block diagram of an exemplary embodiment of a system 16000;

FIG. 17 is a block diagram of an exemplary embodiment of an information device 17000; and

FIG. 18 is a flowchart of an exemplary embodiment of a method 18000.

Definitions

When the following terms are used substantively herein, the accompanying definitions apply:
a—at least one.
above-NEMA motor—a motor that has a frame size larger than a NEMA frame size. These motors typically range in size from 200 to 10,000 horsepower.
accessory requirements—motor supplements that are expressly and/or impliedly preferred and/or specified by a customer.
ActiveX—a set of technologies, based on COM, for sharing information between different software applications.
activity—an action, act, step, and/or process or portion thereof.
adapted to—made suitable or fit for a specific use or situation.
adjust—to change, modify, adapt, and/or alter.
analysis—an evaluation of the constituents of.
and/or—either in conjunction with or in alternative to.
apparatus—an appliance or device for a particular purpose.
automatically—acting or operating in a manner essentially independent of external influence or control. For example, an automatic light switch can turn on upon “seeing” a person in its view, without the person manually operating the light switch.
can—is capable of, in at least some embodiments.
comply—to act in accordance with a specification, command, request, and/or wish.
component—a constituent element and/or part.
Component Object Modeling (COM)—a software architecture developed by Microsoft to build component-based applications. COM objects are discrete components, each with a unique identity, which expose interfaces that allow applications and other components to access their features.
comprising—including but not limited to.
configuration—an arrangement of parts and/or elements.
continuously—in a manner uninterrupted in time, sequence, substance, and/or extent.
cost information—data regarding expenditures to create, manufacture, test, and/or supply.
customer—a potential purchaser of goods and/or services.
customer design requirements—motor performance and/or dimensional parameters that are expressly and/or impliedly preferred and/or specified by a customer.
data—distinct pieces of information, usually formatted in a special or predetermined way and/or organized to express concepts.
define—to establish the outline, form, and/or structure of.
determine—to obtain, calculate, decide, and/or establish.
develop—to bring toward and/or to fulfillment; to bring into being; and/or to grow.
device—a machine, manufacture, and/or collection thereof.
electrical data—information regarding the electrical requirements of a motor.
engineering drawing—a drawing containing design information. Examples include a dimensioned drawing, one-line drawing, schematic, performance curve, flow sheet, block diagram, perspective view, illustration, photograph, etc.
factory approval—a sanction, agreement, and/or commendation by an entity responsible for manufacturing an item.
frame size—a standardized set of motor dimensions that include bolt hole size, mounting base dimensions, shaft height, shaft diameter, and shaft length.
generate—to create, provide, and/or render.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
identify—to specify, correlate, recognize, and/or detect.
induction motor—an asynchronous motor.
information device—any device capable of processing information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
machine instructions—directions adapted to cause a machine to perform a particular operation or function.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
modification—an alteration, change, and/or adjustment.
National Electrical Manufacturers Association (NEMA)—a non-profit standard-setting organization organized and supported by manufacturers of electric equipment and supplies.
network—a communicatively coupled plurality of nodes.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
operate—to perform a function and/or to work.
operative embodiment—an implementation that is in operation and/or is working as designed.
perform—to take action, do, fulfill, and/or accomplish.
performance curve—a graphical chart rendering information regarding operating characteristics of an electric motor. For example, performance curves can graphically display motor RPM vs. torque, current, and/or power factor, etc.
plurality—the state of being plural and/or more than one.
portion—a part of whole.
predetermined—established in advance.
price—an amount of money and/or goods asked for and/or given in exchange for something else.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or formnware at least a part of an embodiment disclosed herein.
proposal—a rendered offer to provide a good and/or a service at an indicated price.
provide—to furnish, supply, and/or make available.
query—a search request.
rating—a performance capability.
real-time—substantially contemporaneous to a current time. For example, a real-time transmission of information can be initiated and/or completed within about 120, 60, 30, 15, 10, 5, and/or 2, etc. seconds of receiving a request for the information.
receive—to get, obtain, acquire, and/or take.
render—make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
require—to compel, demand, need, and/or request.
search—to look thoroughly in order to find something.
secure access—an approach, entry, communication with, and/or use that is substantially free from danger, snoop, attack, and/or risk of unauthorized listening, monitoring, and/or conduct.
set—a related plurality.
squirrel cage—the most common type of rotor used with asynchronous motors, the rotor comprising a shaft, a stack of steel laminations with evenly spaced conductor bars around the circumference, and end rings mechanically and electrically connecting the conductor bars.
store—to place, hold, and/or retain data, typically in a memory.
submit—to provide; to offer; and/or to subject to a condition and/or process.
substantially—to a great extent or degree.
system—a collection of mechanisms, devices, data, and/or instructions, the collection designed to perform one or more specific functions.
testing requirements—motor trials and/or evaluations that are expressly and/or impliedly preferred and/or specified by a customer.
user interface—any device and/or software program for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
validate—to establish the soundness of. For example, to compare an input against at least one standard.
via—by way of and/or utilizing.

### DETAILED DESCRIPTION

The present application describes certain exemplary embodiments of systems and methods for automated proposal generation, tracking, and/or management.

Certain exemplary embodiments of the systems and/or methods can be viewed as web-based software tools adapted for use by sales entities and/or related support personnel, such as Application Engineers (AEs), that seek to provide professional and/or technical sales proposals, such as sales proposals for above-NEMA squirrel cage motors. Certain exemplary embodiments of the software tools can provide automated analysis of customer inputs, needs, specifications, and/or requirements. Certain exemplary embodiments of the software tools can automatically provide cost analysis, electrical data, performance curves, and/or dimensional drawings, etc.

Certain exemplary systems and/or methods for automated proposal generation, such as the systems and/or methods referred to herein as Siemens Norwood Automated Proposal (SNAP), can be web-based, which can provide any of the following potential benefits:
Speed of the application.
Assures consistency of both program version and data (eliminates having to distribute updates and rely on users to install on their PCs).
Simplifies maintenance and future updates: Adding new design data or making cost adjustments for market conditions, for example, is done only one time on the server; individual users do not need to perform any such tasks.
Ability to track quotation activity for all induction motors, not just AE quotes.

Certain exemplary systems and/or methods for automated proposal generation can utilize, address, and/or comprise any of the following features, characteristics, and/or components:
Horizontal Frames: 500, 580, 680, 708, 788, 880, 800, 1120, and/or Explosion-proof 30
Vertical Solid Shaft Frames: Pricing only for 500, 580, 680, 800, 1120, and/or Explosion-proof 30
Enclosures
Price, data, and/or drawings for: ODP, WPI, WPII, TEFC, TEAAC, and/or TEWAC
Pricing and data only for: TEFV and/or TEPV
Pricing only for: Explosion-proof and/or TEAO
3-phase Squirrel Cage Induction
Voltage up to 7200V
Single Speeds up through 16-pole
VFDs: Low Voltage (LV) and Filtered Medium Voltage (MV) for Variable Torque (VT) and for Constant Torque (CT) up to 2:1 speed ratio
High Inertia up to 4× NEMA limits for 4, 6 and 8 pole speeds. Up to 1× NEMA for 2-pole speed
IEC 34 (electrical)
50 and 60 Hz
API 541 3rd Ed., General Purpose
EEE 841
Variable rating inputs such as non-standard HP or kW, temperature rise, ambient, and altitude
Tabular formatted output
Optional features pricing
Standardized comments for common specs
Web-based interface
Ability for sales force to price motors that do not have published list prices
   Functional Requirements

Certain exemplary embodiments can utilize any of the following functional objectives, goals, specifications, and/or requirements, which can describe what the system is supposed to do and/or specify the following information: Users, Data, Functions (application-based and/or product design-based), Interfaces, Security, and/or System Outputs.

Users

This section can identify the users of SNAP and their roles with regard to using the program.
Outside Sales (OS)—individuals in this role typically can coordinate and/or generate proposals for their assigned customers. They typically do not have access to cost information. They typically have access only to those proposals they have created or Inside Sales (IS) or AEs have created for them.
Inside Sales (IS)—individuals in this role typically can coordinate and generate proposals for their assigned OS personnel. They typically do not have access to cost information. They typically have access to those proposals created by themselves, other IS personnel within the same COE, or their assigned OS personnel.
Application Engineers (AE)—individuals in this role typically can coordinate and generate proposals to requests submitted by the sales organization. The AEs typically have access to cost information and all proposals.
System Administrator (AD)—individuals in this role typically maintain the the program software and database tables.
   Data

This section identifies potential data requirements for certain, but not necessarily all, exemplary embodiments of SNAP. Descriptions of both database records and user inputs are included.

User Database Record

The SNAP user typically must have the following data attributes:

| Attribute | Definition |
|---|---|
| User Name | The first and last name of the user |
| User ID | The network ID of the user |
| Email | The email address of the user |
| Phone | The phone number of the user (E.g. 513.682.1104) |
| Fax Number | The fax number of the user (E.g. 513.393.3933) |
| CofE | Center of Excellence, COE, from which OS or IS user is |
| | based |
| Address1 | Street Number, Name and Building Identification |
| Address2 | Street Number, Name and Building Identification |
| City | City |
| State/Province | State or Province |
| Country | Country Name |
| Title | The title of the user. (E.g. Account Executive) |
| Role | Role used to define access privileges |
| Password | The password of the user |

For system access, a valid SNAP user typically must have a User ID that is the same as their Network ID defined in the system.

Role Security Access Database Record

The Role Security Access Record can define the security restrictions on users. It can have the following data attributes:

| Attribute | Definition |
|---|---|
| Role | OS, IS, AD or AE |
| All Access | Flag indicating all costs and proposals are accessible to user |
| Cost Access | Flag restricting access to cost figures |
| Support | Indicates IS-OS-COE relationship with regards to proposal |
| Access | access |
| Approval | Flag indicating authorization to approve special items |

Customer Database Record

A customer in the SNAP program can have the data attributes listed in the table below. At a minimum, typically only the user and customer name will be required. The user typically must input only the customer name. SNAP can automatically set the user attribute to the current user's ID.

| Attribute | Definition |
|---|---|
| User | SNAP User login ID |
| Customer Name | Name of customer receiving the proposal |
| Address1 | Street Number, Name and Building ID of customer |
| Address2 | Street Number, Name and Building ID of customer |
| City | City of customer |
| State/Province | State or Province of customer |
| Zip | Customer zip code |
| Country | Country Name of customer |
| Contact Name | Contact Name of customer |
| Email Address | Contact email address of customer |
| Index | Index number assigned to customer |
| Type | Customer's classification |
| Default | Yes/No attribute for user |

Proposal Database Record

A Proposal Record in the SNAP program can have the data attributes listed in the table below. The minimum input typically required of the user is the factory (AE), or field sales (OS or IS), proposal number. All other fields can be optional, however, the more information that is provided can enhance the ability to search for and/or retrieve the proposal for future modifications.

| Attribute | Definition |
|---|---|
| Unique Proposal Number | Random number generated by SNAP as key |
| | identifier |
| Factory Proposal Number | AE's quote number for proposal, if applicable |
| Revision | Revision number of proposal |
| Owner | SNAP user creating the proposal |
| End User | End user of the motor(s) (not necessarily direct |
| | customer) |
| Project Name/Site | End user's or customer's project name or |
| Location | jobsite location |
| Engineering Firm | Name of engineering firm or contractor |
| Creation Date | Proposal creation date |
| Motor Specification | Customer document/specification reference |
| Owner C of E | Sales region location of customer |
| Industry | Descriptor of end user |
| Specification Comments | Exceptions and clarifications to customer |
| | requirements, including auto-generated |
| | comments |

Line Item Database Record

The Line Item Record of a proposal in SNAP can have the data attributes as listed in the following table. A proposal can contain multiple line items, and each can be associated with a different salesperson and customer.

| Attribute | Definition |
|---|---|
| Unique Proposal | Key identifier tied to Proposal Database Record |
| Number | |
| Line Item Number | Sequential number generated by SNAP; key |
| | identifier for this record |
| Revision Number | Number generated by SNAP |
| Salesman Name | OS assigned to line item |
| Motor Title | Descriptor to distinguish motor from others on |
| | same proposal; can be Customer Item Number, if |
| | provided |
| Application | Type of driven equipment |
| RPM | Synchronous speed of a motor |
| HP | Horsepower required by customer |
| Power | Motor's power expressed in either HP or KW |
| | depending upon customer preference |
| Frame | Frame determined from the user inputs |
| Core Length | Length of motor stator core determined by user's |
| | inputs |
| Voltage | Nameplate rated voltage |
| Frequency | Number of cycles in a time period of one second. |
| Rotor | Type of rotor material |
| Enclosure | Type of enclosure required by customer, using |
| | NEMA designations |
| Bearings | Type of bearings |
| List Price | List Price, including modifications specified |
| Quoted Price | Net price given to the customer |
| Cost | Cost of motor, including modifications specified |
| Customer Name | Customer (not necessarily the End User) |
| Customer ID | Customer identification number |
| Customer Type | Customer's classification |
| Customer Reference | Optional field for customer to identify motor |
| number | |
| Field Proposal | Optional field for IS or OS to identify proposal |
| Number | |
| VFD | Variable Frequency Drive application |
| Enclosure Type | Internal designation for enclosure type |
| Orientation | Describes whether motor is horizontal or vertical |
| Quantity | Quantity of motors for line item |
| Submittal Date | The date the proposal is submitted |
| Bid Received Date | The date the proposal received |
| Bid Due Date | The date the proposal is due |
| Framing CUD | SNAP-generated data stream describing motor |
| | rating |
| Lead Time | Total lead time required to produce motor. |
| Include In Proposal | Yes or No to designate if a line item is to be |
| | included in the printed proposal. |
| Assigned C of E | The sales region location of the customer |
| Noise | Sound level of motor |
| Price Method Name | One of the methods that user can use to determine |
| | quoted price - Multiplier, Net_Price, or SCR. |
| | (Only AD or AE can use SCR) |
| Price Method | The actual value used from the Price Method Name |
| Number | |
| Accessory Valid | Indicator that motor's accessories have been |
| | determined and validated |
| Price Valid | Indicator that motor's price has been determined |
| | and validated. |
| Address1 | Street Number, Name and Building ID of customer |
| Address2 | Street Number, Name and Building ID of customer |
| City | City of customer |
| State/Province | State or Province of customer |
| Zip | Zip code of customer |
| Country | Country Name of customer |
| Contact Name | Contact Name of customer |
| Email Address | Contact email address of customer |
| FA Status | Boolean (True/False) that line item required factory |
| | (AD or AE) approval. |
| FA SCR | The SCR level used by the AD or AE. |
| FA Approver | The User ID of the AE. |
| Main Box | Terminal box identifier name |
| Customer Master | Index number from Master Customer List |
| Index | |
| LI Create Date | Date line item was created in database |

Special Items Database Record

The Special Items of a Line Item in SNAP can be those features that require factory approval. They can include motor framing requirements, accessories, or tests. They can have the following data attributes:

| Attribute | Definition |
|---|---|
| Unique Proposal | Key identifier tied to Proposal Database Record |
| Number | |
| Line Item Number | Key identifier tied to Line Item Database Record |
| Special Item | Sequential number generated by SNAP for this item |
| Number | |
| Request | Text description of special request |
| Factory Reply | Comments from the factory |
| Cost | Cost of special; not seen on proposal |
| Price | Price of special; included in proposal pricing |
| Approved | Flag indicating approval given |
| Pricing Type | Adder, Ghost, or Option |
| Category | Indicates if special is for motor frame, accessory or |
| | test |

The different Pricing Types are defined as follows:
Adder: Price is to be added to Base Price of Motor.
Ghost: Price is to be added to Base Price of Motor, but not listed in proposal, but included in BOM.
Option: Price is NOT to be added to Base Price of Motor, but is listed separately.
   User Inputs

Proposal and Line Item Inputs—Non-technical

| Attribute | Definition | Data type |
|---|---|---|
| Quantity | Number of motors per line | Numeric |
| | item | |
| Customer Name | Customer name - free field | String variable or |
| | | list box |
| AE Quote Number | Free field | String variable |
| Sales Quote | Free field | String variable |
| Number | | |
| Sales Person | List of sales people | List box |
| End User Name | Free Field | String variable |
| Site Location | Free field | String variable |
| Engineering Firm | Free field | String variable |
| Lead Time | Number of days to build | Numeric |
| | motor | |
| Extended Warranty | Period of time after shipment | List box |
| | and/or after installed | |
| | operation expressed in | |
| | months beyond the standard | |
| | warranty period | |
| Deferred Warranty | Period of time after shipment | List box |
| | expressed in months beyond | |
| | the standard warranty period. | |

Framing Inputs

These inputs can impact the motor's basic design. Those indicated with an asterisk can be the minimum inputs required of the user. All remaining inputs can have a standard default that can be either accepted or modified by the user. This can permit the user to obtain a budgetary price for a simple motor quickly.

| Attribute | Definition | Data type |
|---|---|---|
| Orientation* | Horizontal or Vertical | Radio |
| | | buttons |
| Enclosure* | ODP, WPI, WPII, TEFC . . . | List box |
| Power* | HP or Kilowatts | Numeric |
| Kilowatt Flag | HP or Kilowatts | Boolean |
| Voltage* | 380, 460, 2300, 4000 . . . | List box |
| RPM* | 3600, 3000, 1800, 1500 . . . | List box |
| Frequency* | Number of cycles in a time period | Radio |
| | of one second. | buttons |
| Altitude | Site elevation of motor | Numeric |
| Ambient | Temperature | Numeric |
| Service Factor | 1.0 or 1.15 | Radio |
| | | buttons |
| Temp Rise | Temperature rise of the stator | List box |
| Min LRT | Minimum locked rotor torque | Numeric |
| Max LRT | Maximum locked rotor torque | Numeric |
| Min BDT | Minimum breakdown torque | Numeric |
| Min RPM | Minimum speed on compressor | Numeric |
| | aps | |
| Min Eff | Minimum efficiency | Numeric |
| Load inertia | Units are foot-pounds squared | Numeric |
| Load points | Intersecting points from a | Numeric |
| | graphical load curve | |
| Min Accel Time | Minimum acceleration time | Numeric |
| Max Accel Time | Maximum acceleration time | Numeric |
| Max LRA | Max locked rotor (in-rush) current | Numeric |
| Reduced Volt Start | % of rated voltage for starting | Numeric |
| Rotor Construction | Aluminum die-cast or copper bar | Check Box |
| Bearing | Antifriction or sleeve | Check Box |
| Hazardous Class | Class 1 or 2 | Check Box |
| Hazardous Group | Groups B, C, D, F or G | Check Box |
| Hazardous Division | Division 1 or 2 | Check Box |
| API 541 | 3^{rd} Edition General Purpose only | Check Box |
| IEEE 841 | Institute of Electrical and | Check Box |
| | Electronics Engineers Standard | |
| | 841 | |
| IEC 60034-XX | International Electrotechnical | Check Box |
| | Commission Standard 60034-XX | |
| VFD | Variable frequency drive | Check Box |
| Dual Voltage | A motor's electrical connection so | Check Box |
| | that motor can be utilize different | |
| | power sources. | |
| Wye/Delta Start | A motor's electrical connection | Check Box |
| | used to reduce the motor's inrush | |
| | current and torque. | |
| Continuous Down | Amount of external thrust in | Numeric |
| Thrust | pounds imposed upon the motor | |
| | bearing by the application | |
| Bearing L10 Life | Calculated estimate of the motor | Numeric |
| | bearing's life in the application | |
| Application | Driven Equipment | List box |

Accessory Inputs

User can select accessories and indicate whether they are to be included in the base motor's price or listed as a separate option.

The program can automatically add accessories that are a standard part of an enclosure. Accessories that are not valid for a given enclosure need not be selectable for that enclosure.

| Attribute | Definition | Data type |
|---|---|---|
| Stator RTDs | Din or Std | Radio |
| | | button |
| Stator Thermocouple | | Radio |
| | | button |
| Stator Thermostats | | List box |
| Stator Thermistors | | List box |
| PTC Thermistor Control Mod. | | List box |
| Stator Transmitter | | Check box |
| Stator RTD Shielding | | List box |
| Space Heaters | | List box |
| Bearing RTDs | Embed, Stick, Dual, DIN | Radio |
| | | button |
| Bearing Thermocouples | | Radio |
| | | button |
| Bearing Thermometer | | List box |
| Bearing Transmitter | | List box |
| Bearing Insulation | NDE or Both with Strap | List box |
| Belt Drive | | Check box |
| Rotating Seal (Inpro\JM Clipper) | | List box |
| Oil Guard Material | | List box |
| Oil Mist | | List box |
| Oil Purge | | List box |
| Flood Lube | | Check box |
| Constant Level Oilers | | List box |
| Sump Heaters | | List box |
| Vibration Switches | | List box |
| Transducers | | List box |
| Proximity Probe | | List box |
| Key Phaser | | List box |
| Ground Brush | | List box |
| Slide Rails | | List box |
| Sole Plates | Std, API | List box |
| Jacking Screws (Vertical) | | List box |
| Shaft N-W | | Numeric |
| Shaft U | | Numeric |
| Rotor Balance | Includes precision, API, 3- | List box |
| | plane | |
| Mount Half Coupling | | List box |
| Anti Fungal Treatment | | List box |
| Anti Abrasion Treatment | | List box |
| Differential Pressure | | List box |
| Switch\Gage | | |
| Aux Blower | | List box |
| Tachometer | | List box |
| Fan Material | | List box |
| Fan Housing Material | | List box |
| Filters | | List Box |
| Class H Insulation | | List box |
| Noise | | List box |
| Heavy Duty Bracing | | List box |
| D Flange | | List box |
| Removable Bottom Plate | | List box |
| Terminal Box Size | | List box |
| Aux Box Material | | List box |
| Main Box Material | | List box |
| Metering CT | | List box |
| Differential CT | | List box |
| Surge Caps | | List box |
| Lightning Arrestors | | List box |
| Iris Couplers | | List box |
| Elastimolds | | List box |
| Standoff Insulators | | List box |
| Term Box Heaters | | List box |
| Removable Link | | List box |
| Six Leads out | | List box |
| Copper GND Pads | | List box |
| GND Bus in T-Box | | List box |
| Thermal Insulation in T-Box | | List box |
| Breather Drain in T-box | | List box |
| Breather Drain in Motor | | List box |
| T-box Purge | | List box |
| Silver Plated Bus Bar | | List box |
| Separate Aux Boxes | | List box |
| Blow out panel | | List box |
| Zero Speed Switch | | List box |
| Bonding Strap | | List box |
| Leak Detector | | List box |
| Flow Indicator | | List box |
| Tube Material (TEWAC) | | List box |
| Tube Material (TEAAC) | | List box |
| Air RTD | | List box |
| Normalized Shaft Material | | List box |
| Forged Shaft Material | | List box |
| NRR | | Check box |
| Vertical Bearing Options | Tandem, Kingsbury | List box |
| API 610 Shaft and Flange Toler. | | Check box |
| Stub Shaft\Pump Bracket | | List box |
| Paint Process | | List box |
| 316 Hardware | | List box |
| Phosphorous free brazing | | List box |
| Copper Pressure tube | | List box |
| Shim Packs | | List box |
| ABS | | List box |
| CSA | | List box |
| Export Boxing | | List box |
| Shaft certs | | List box |
| Assy, maint and running | | List box |
| clearances | | |
| Bi-Lingual Nameplates\Manuals | | List box |
| Torsional Data (aka Mass | | List box |
| Elastic) | | |
| Current Pulsation Analysis | | List box |
| Lateral Critical Speed Analysis | | List box |
| Foundation Information | | List box |

Test and Inspection Inputs

The user can select tests and/or inspections, indicate whether they are to be included in the base motor price or listed as a separate option, and/or whether they are to be unwitnessed or witnessed. Since the Routine test can be standard for any motor, only a witnessed version need be selectable. Tests or inspections followed by “API 541” in parentheses can indicate that the item can be performed to meet the API 541 3rd Ed. specification.

Lead-time impact can be added to the motor's lead-time as needed.

| Attribute | Definition | Data type |
|---|---|---|
| Routine Test | | List box |
| Routine Test (API 541) | | List box |
| Complete Test | | List box |
| Complete Test (API 541) | | List box |
| Stray Load Test | | List box |
| Speed-torque and -current Curve Test | | List box |
| Bearing Temperature Test | | List box |
| Efficiency Test | | List box |
| Sound Test (walk-around) | | List box |
| Sound Room Test | | List box |
| Check balance with 1/2 coupling (API 541) | | List box |
| Residual Unbalance Test (API 541) | | List box |
| Vibration Recording (API 541) | | List box |
| Stator Core Test (API 541) | | List box |
| Surge Test on Sample Coils (API 541) | | List box |
| Power Factor Tip-up Test (API 541) | | List box |
| Sealed Winding Conformance Test (API 541) | | List box |
| DC Hi-pot Test (API 541) | | List box |
| Rated Rotor Temp Test (API 541) | | List box |
| Unbalance Response Test | | List box |
| Bearing Housing Natural Frequency Test | | List box |
| Ultrasonic of shaft or bearing (API 541) | | List box |
| Magnetic Particle Inspection of shaft welds | | List box |
| (API 541) | | |
| Liquid Penetrant Inspection of yoke welds | | List box |
| (API 541) | | |
| Pre-VPI Stator Inspection | | List box |
| Bearing Inspection per API 541 4.3.5.1.2 | | List box |

Printing Inputs

| Attribute | Definition | Data type |
|---|---|---|
| Cover Letter | | Check box |
| Quotation (Pricing and T&Cs) | | Check box |
| Data Sheet | | Check box |
| Curves - Speed Torque and Current | | Check box |
| Curves - Thermal | | Check box |
| Curves - pf vs. Speed | | Check box |
| Curves - Eff, pf, Current vs. Load | | Check box |
| Drawing - DXF | | Check box |
| Drawing - PDF | | Check box |
| Drawing - DFT | | Check box |
| Tabular Output Format | | Check box |

Application Functions

The Application Function requirements can specify what operations/processes the system can support to manage the proposal process. SNAP can support any of the following abilities:
Create a new proposal that can have Project Name, Customer Name, Outside Sales Name, and/or Unique Proposal Number.
Select existing proposals by searching the database using parameters such as User(s), Project Name, Customer Name, Outside Sales Name, Unique Proposal Number, and/or Bid Date to filter the list.
Modify and copy existing proposals.
Modify and copy existing line item information within a proposal.
Generate and download proposal documents to a local PC (Proposal Quotation in a format compatible with MS Word, Data and Curves in a format compatible with MS Excel, and Drawings in Solid Edge).
   Product Design Functions

The Product Design function requirements can specify what operations/processes the system can support to accurately generate a product. In this case, the “product” is a proposal containing a price quotation, as a minimum, and possibly data, curves, and/or a drawing. SNAP can support any of the following functions:
Rule-based validation of standard motor design, accessory, and/or test selections.
Validate customer design goals and/or inputs to the Engineering Design Program, resulting in a valid motor design.
Automatically generate unique proposal number.
Automatically generate proposal line item number.
Automatically generate revision number (initial value of 0).
Capture special items (those requiring factory approval). Specials can require submission to the factory for cost, price, availability, and pricing type.
Add, delete, update, and/or view Special Item details.
Void approved special items if line item is subsequently changed after approval given.
Add, delete, update, and/or view the proposal and/or line item data as changes from customers warrant. This can include modifying motor design inputs, accessories and/or tests, and/or comments as customer specifications/requirements change.
Ability to adjust warranty conditions.
Negotiation/evaluation ability: adjust the proposed price for line items and options based upon SCR (AE only), multiplier, and/or proposed net price (the latter provided as competitive feedback from the customer).
Offer accessories, inspections, and/or tests as options.
   Interfaces

This section identifies typical requirements for the User and System Interfaces. User Interface requirements can specify guidelines to be used during design and construction. For System Interfaces, there can be three primary sections that can be addressed in terms of building the interface between the systems—Data Field Mapping, Data Synchronization and Data Maintenance.

User Interface

A Web-based application incorporating standard features such as:
Point and click buttons and lists
Free text fields
Associated menu selections
Drag and Drop
On-line help
   System Interface—Solid Edge

Solid Edge is a parametrically driven CAD package that can be used by Engineering. The motor parameters can be used by the Solid Edge system to generate motor CAD dimensional drawings.

Data Field Mapping

Inputs to Solid Edge

| Variable | Comments |
|---|---|
| Frame | 508, 5010, 588, 5810 . . . |
| Bearings | AF or Sleeve |
| U | Shaft Diameter |
| N-W | Shaft Extension Length |
| Noise | |
| Enclosure | ODP, WPI, WPII . . . |
| T-box Size | |
| Mounting | F1 or F2 |
| Aux Box Type | |
| Aux Box Location | |
| Aux Box Qty | |
| Flange | |
| Ground Brush | |
| Orientation | |
| Inpro Seal | |

Drawing Output Formats

| Drawing Formats | Definition |
|---|---|
| DXF | Drawing Exchange Format - AutoCAD |
| PDF | Adobe file. |
| DFT | Native Solid Edge draft format |

Data Synchronization

The Solid Edge interface can use a real-time COM interface into which input data required to drive the CAD model will be populated, then executed, via a programmed call for execution of the drawing.

Data Maintenance

Engineering Administration will maintain the Solid Edge interface with SNAP.

System Interface—Engineering Design Program

The Engineering Design Program can be used by Engineering to generate the electrical design of the proposed motor.

Data Field Mapping

| Variable Name | Definition | Comments |
|---|---|---|
| XXKP | | Not used; functionality |
| | | retained |
| XXKD | | Not used; functionality |
| | | retained |
| XXST | | Not used; functionality |
| | | retained |
| XXSEC | | Not used; functionality |
| | | retained |
| XZZ5 | | Not used; functionality |
| | | retained |
| XXRT | | Not used; functionality |
| | | retained |
| XXER | | Not used; functionality |
| | | retained |
| XBM | | Not used; functionality |
| | | retained |
| TYM | Motor Frame (500, 580, etc) | |
| FL | Core Length | |
| STV(1) | Reduced Voltage Value 1 | |
| STV(2) | Reduced Voltage Value 2 | |
| STV(3) | Reduced Voltage Value 3 | |
| STV(4) | Reduced Voltage Value 4 | |
| TYPMTR | Motor Type (Open or | |
| | Enclosed) | |
| XBEN | Bend Bar Factor | Not used; functionality |
| | | retained |
| HP | Horsepower | |
| RPM | Synchronous RPM | |
| VOLTS | Rated Volts | |
| SFAC | Service factor | |
| WK21 | Inertia of the driven load | |
| RISE | Expected temp rise of stator | |
| FREQ | Frequency of the power | |
| | supply | |
| DI | Inside dia of stator lamination | |
| DE | Outside dia of stator | |
| | lamination | |
| GAP | Air gap | |
| XDIR | Effective Rotor ID | |
| SNUI | Type of steel used in stator | |
| RNUI | Type of steel used in rotor | |
| RSLT5(29) | Dummy air gap | No longer used |
| RSLT(15) | Coreloss calculation method | Not used; functionality |
| | | retained |
| CVS | # of stator vents | |
| CVW | Stator vent width | |
| CVR | # of rotor vents | |
| CVWR | Rotor vent width | |
| SKW | Skew factor of rotor | Not used; functionality |
| | | retained |
| ECE3 | Tooth tip saturation | Not used; functionality |
| | | retained |
| SSL | # of stator slots | |
| RSLT5(28) | Stator slot type | |
| SFF | Stacking factor | |
| D1 | Stator slot dim | |
| D3 | Stator slot dim | |
| W3 | Stator slot dim | |
| W1 | Stator slot dim | |
| D2 | Stator slot dim | |
| W2 | Stator slot dim | |
| R1R | Stator slot dim | |
| R2R | Stator slot dim | |
| R3R | Stator slot dim | |
| W4 | Stator slot dim | |
| CLTYP | Coil type | Standard/Cone |
| TYPWDG | Winging type | Standard/Interspersed |
| RSL | # of rotor slots | |
| RSN | Rotor slot type | |
| BRE | Rotor bar resistance | |
| RSLT(1) | Rotor slot dim | |
| CDI | Rotor slot dim | |
| A8 | Rotor slot dim | |
| CDIM | Rotor slot dim | |
| RSLT5(11) | Rotor slot dim | |
| RSLT5(12) | Rotor slot dim | |
| RSLT5(14) | Rotor slot dim | |
| RSLT(8) | Rotor slot dim | |
| RSLT(7) | Rotor slot dim | |
| RSLT5(1) | Rotor slot dim | |
| RSLT5(2) | Rotor slot dim | |
| RSLT5(3) | Rotor slot dim | |
| NCASE | Rotor material | Copper/Aluminum |
| RW | End ring width | |
| RINO | End ring OD | |
| RINI | End ring ID | |
| RCOE | Distance from ring to core | |
| RRE | End ring resistance | |
| RCOW | Distance from weld to core | Not used; functionality |
| | | retained |
| RINE | Diameter of ring embedded | Not used; functionality |
| | | retained |
| RTEMP | Expected rise of rotor | |
| RA | End ring area | Not used |
| RMD | End ring mean diameter | Not used |
| SCL(13) | Coil loop pin | |
| CS | Conductors per slot | |
| ECK | Circuit and connection | |
| CP | Pitch | |
| DEEP | # of wires deep of strand 1 | |
| XSTR(1) | Thickness of strand 1 | |
| WIDE | # of wires wide of strand 1 | |
| XSTR(2) | Width of strand 1 | |
| XLE2 | LE2 dimension | |
| DEEP2 | # of wires deep of strand 2 | |
| STR2(1) | Thickness of strand 2 | |
| WIDE2 | # of wires wide of strand 2 | |
| STR2(2) | Width of strand 2 | |
| XLE1 | LE1 dimension | Not used |
| CA | Copper area | Not used |
| XMLT | Coil mean turn length | Not used |
| SCL(3) | Coil D dimension | Not used |
| RMM | Indicates form or random | |
| | wound coil | |
| D2N | D2N of slot | |
| ETC | End turn clearance | |
| APB | Coil A + B dimension | Not used |
| SINS | Conduction strand thickness | |
| GINS | Ground wall thickness | |
| FILBOT | Filler bottom | |
| BETFIL | Filler in between coils | |
| TOPFIL | Top filler | |
| EP | Clearance between coils | |
| CLRCE | Conductor width allowance | |
| DP | Coil drop | |
| CINS | Turn insulation | |
| CL1 | Core loss | |
| WF1 | Windage and friction | |
| STRAL | PU stray loss | |
| AB | Load curve type | |
| STL | Load at full speed | |
| CLMLT | Core loss multiplier | |
| ALO(2, 1) | RPM for load curve point 1 | |
| ALO(2, 2) | Torque for load curve point 1 | |
| ALO(3, 1) | RPM for load curve point 2 | |
| ALO(3, 2) | Torque for load curve point 2 | |
| ALO(4, 1) | RPM for load curve point 3 | |
| ALO(4, 2) | Torque for load curve point 3 | |
| ALO(5, 1) | RPM for load curve point 4 | |
| ALO(5, 2) | Torque for load curve point 4 | |
| ALO(1, 1) | Torque for load curve at start | |
| COILDWGNUM | Coil drawing number | |

Data Synchronization

The Engineering Design Program interface can use a real-time ActiveX COM interface into which input data required to drive the Engineering computations can be populated, then executed, via a programmed call for execution. The output parameters can be retrieved via the same ActiveX COM interface.

Data Maintenance

Engineering Administration can maintain the Engineering Design Program interface with SNAP.

Performance Curves

Performance Curves can be used by Engineering/Marketing to display the performance of the motor in a graphical fashion.

Data Field Mapping

| Variable Name | Definition | Comments |
|---|---|---|
| Poles | # of poles | |
| NumStator Slots | # of stator slots | |
| NumRotorSlots | # of rotor slots | |
| Pitch | Pitch of winding | |
| Volts | Rated volts | |
| Freq | Rated freq | |
| RotorH | Rotor slot dimension | |
| RotorE | Rotor slot dimension | |
| RotorQ | Rotor slot dimension | |
| RotorT | Rotor slot dimension | |
| RotorY | Rotor slot dimension | |
| BRE | Rotor bar resistance | |
| BM | Equivalent circuit parameter | |
| R1 | Equivalent circuit parameter | |
| REB1 | Equivalent circuit parameter | |
| RBE | Equivalent circuit parameter | |
| RR1 | Equivalent circuit parameter | |
| R2 | Equivalent circuit parameter | |
| X1SAT(N) | Equivalent circuit parameter | |
| X2SAT(N) | Equivalent circuit parameter | |
| R2PU(N) | Equivalent circuit parameter | |
| CUST RPM | Rated RPM | |
| HP | Horsepower | |
| CUSTLRT | Rated locked rotor torque | |
| CUSTBDT | Rated breakdown torque | |
| RotorInertia | Rotor inertia | |
| CustomerInertia | Customer inertia | |
| ALO(2, 1) | RPM for load curve point 1 | |
| ALO(2, 2) | Torque for load curve point 1 | |
| ALO(3, 1) | RPM for load curve point 2 | |
| ALO(3, 2) | Torque for load curve point 2 | |
| ALO(4, 1) | RPM for load curve point 3 | |
| ALO(4, 2) | Torque for load curve point 3 | |
| ALO(5, 1) | RPM for load curve point 4 | |
| ALO(5, 2) | Torque for load curve point 4 | |
| ALO(1, 1) | Torque for load curve at | |
| | starting | |
| PFsp(n) | Power factor vs. speed | |
| EF(n) | Efficiency vs. load | |
| PF(n) | Power factor vs. load | |

Data Synchronization

The Performance Curve interface can utilize a real-time ActiveX COM interface in which input data that is required to drive the Engineering computations can be populated then executed via a programmed call for execution of the Performance Curves.

Data Maintenance

Engineering Administration can maintain the Performance Curve interface with SNAP.

Customer Data Sheets

Customer Data Sheets can be used by Engineering/Marketing to display the performance of the motor.

Data Field Mapping

| Variable Name | Definition | Comments |
|---|---|---|
| Customer | Customer name | |
| Altitude | Rated altitude | |
| Ambient | Ambient Temperature | |
| Temperature | | |
| Bearings | Type of bearings | |
| Custacc100 | Acceleration at 100% voltage | |
| CustaccX | Acceleration at X % voltage | |
| CustAmps | Rated amps | |
| CustBDT | Rated breakdown torque | |
| CustColdStall100 | Rated cold stall time at 100% | |
| | voltage | |
| CustColdStallX | Rated cold stall time at X % | |
| | voltage | |
| CustEff100 | Rated efficiency at 100% load. | |
| CustEff75 | Rated efficiency at 75% load. | |
| CustEff50 | Rated efficiency at 50% load. | |
| CustHotStall100 | Rated hot stall time at 100% | |
| | voltage | |
| CustHotStallX | Rated hot stall time at X % voltage | |
| CustLRC | Rated locked rotor current | |
| CustLRT | Rated locked rotor torque | |
| CustPF100 | Rated power factor at 100% load. | |
| CustPF75 | Rated power factor at 75% load. | |
| CustPF50 | Rated power factor at 50% load. | |
| CustRPM | Rated RPM | |
| DegreesRise | Rated temperature rise | |
| FrameSize | Frame size | |
| FrameType | Frame type | CG, CGZ, CAZ, |
| | | etc |
| Freq | Rated frequency | |
| FullLoadTorque | Rated torque | |
| HP | Rated Horsepower | |
| KVAcode | KVA Code | |
| KVAperHP | KVA per HP | |
| MaxNoise | Max specified noise | |
| MotorWeight | Motor weight | |
| NEMAEnclosure | NEMA Enclosure | ODP, WPI, WPII, |
| | | TEFC |
| OCKT | Open circuit time constant | |
| OrderNumber | Order Number | |
| PFNL | Power factor at no load | |
| RiseBy | Rise by res or det | |
| Rotation | Direction of rotation | |
| RotorInertia | Rotor inertia | |
| RotorType | Rotor construction | Copper or Alum |
| RotorWeight | Rotor weight | |
| SCKT | Short circuit time constant | |
| SF | Service factor | |
| SpcHtrVoltage | Space heater voltage | |
| SpcHtrWattage | Space heater wattage | |
| WhySixLeads | Determines whether the motor is | |
| | Y start/D run or dual voltage | |
| XIM | No load current | |
| XXR | X/R ration | |

Data Synchronization

The Customer Data Sheets interface can use a real-time ActiveX COM interface into which input data required to drive the Engineering computations can be populated, then executed, via a programmed call for execution/creation of the Customer Data Sheets.

Data Maintenance

Engineering Administration can maintain the Customer Data Sheet interface with SNAP.

Security

Access to application data can be limited via logon validation. Passwords can be encrypted.

Application Engineers typically can see all proposals and cost.

Typically only Application Engineers can approve special items.

Outside Sales typically can only see proposals that they create and list and net prices.

Inside Sales typically can only see proposals that they create, the proposals created by their assigned Outside Sales personnel, and list and net prices.

The application can reside on the Corporate DMZ server outside the company firewall in order to allow Outside Sales personnel to access SNAP from customer's sites.

The databases typically reside on predetermined servers inside the firewall for security and maintenance/update ability.

Outputs

Proposal Pricing Quotation

Quotations can be generated in a format compatible with MS Word.

Quotations can use the same Warranty, Terms, and Conditions boilerplate.

Quotations can contain customer and/or outside sales names, motor and/or options description, motor and/or options net pricing, delivery terms, and/or terms and/or conditions.

Proposal Data and Curves

Data and/or curves can be generated in a format compatible with MS Excel.

Proposal Drawing

Drawings can be generated in Solid Edge and/or can have one of the output formats listed above.

Motor Feature Report

Motor Feature Report—a report containing the user selected items and/or specials information.

Thus, certain exemplary systems and/or methods for automated proposal generation can utilize, address, and/or comprise any of the following features, characteristics, and/or components:
Pricing:
   All Horizontal.
   All Vertical, except 2-pole 500 frame open (not yet released from Engineering).
Framing and Data:
   Engineering Design Program can used to frame and produce data and curves for the following:
      500 horizontal, up to 8-pole.
      580 open horizontal, up to 8-pole.
      580 enclosed horizontal, up to 8-pole, except for 5812 (not yet released from Engineering).
      708, 788, 880 horizontal, up to 8-pole.
      680 open, TEWAC, and TEPV, horizontal, up to 8-pole.
   Where design program is not available, motor can be framed based upon frame charts with adjustments made for altitude, temperature rise, and/or hazardous area requirements. This can include:
      Horizontal ratings 10-pole and slower.
      All verticals.
      All horizontal 800 and 1120 frames.
      Typical data is available for explosion-proof horizontals.
Drawings:
   Available for all horizontal 500s.
   All other frames default to the catalog cut sheets.
Primary Functions:
   Search the database for an existing proposal.
   Define motor ratings.
   Select accessories and tests.
   Price motor and options.
   Enter comments and clarifications to customer specifications.
   Print proposal documents for the customers.
Supporting Functions:
   Define personal list of customers.
   Submit field requests to the factory.
Automatic Functions:
   Automatically add accessories required by the motor rating.
   Disable accessories not applicable to the motor rating.
   Verify size of terminal box required based upon accessories selected.

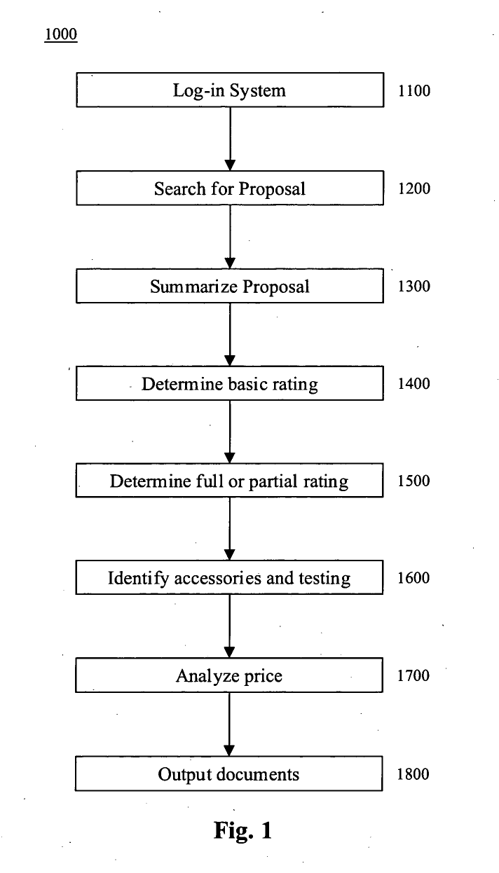

FIG. 1 is a flowchart of an exemplary embodiment of a method 1000 for generating a proposal. At activity 1100, the system can provides a user with a log-in interface, receive the user's log-in information, and/or validate the user.

At activity 1200, the system can provide the user with a proposal searching interface and/or can receive information from the user sufficient to search for and find an existing and/or in-process proposal. If no such information is provided, if inadequate information is provided, and/or if no existing and/or in-process proposal is found, the system can generate a new proposal.

At activity 1300, the system can provide an interface via which information regarding customer specifications, needs, and/or requirements can be entered and/or the proposal can be presented in summary and/or summarized fashion.

At activity 1400, based on the entered customer requirements information, the system can determine and render via an interface a basic rating for a motor that meets the customer's requirements.

At activity 1500, the system can provide an interface where additional customer requirements information and/or other design information can be entered and/or rendered. Depending on the entered customer requirements information and/or other entered desires, the system can determine, provide, and/or render a full and/or partial rating for the motor.

At activity 1600, the system can provide an interface where desired accessories and/or testing can be identified, selected, entered, and/or rendered.

At activity 1700, based on the provided information and/or other information accessible by the system, the system can determine a price for the motor. The system can render an interface via which the determined price can be displayed, analyzed, tested, and/or adjusted.

At activity 1800, documents pertaining to the proposal can be output. For example the system can output a proposal, cost analysis, electrical data, performance curves, and/or engineering and/or dimensional drawings, etc.

Logging In

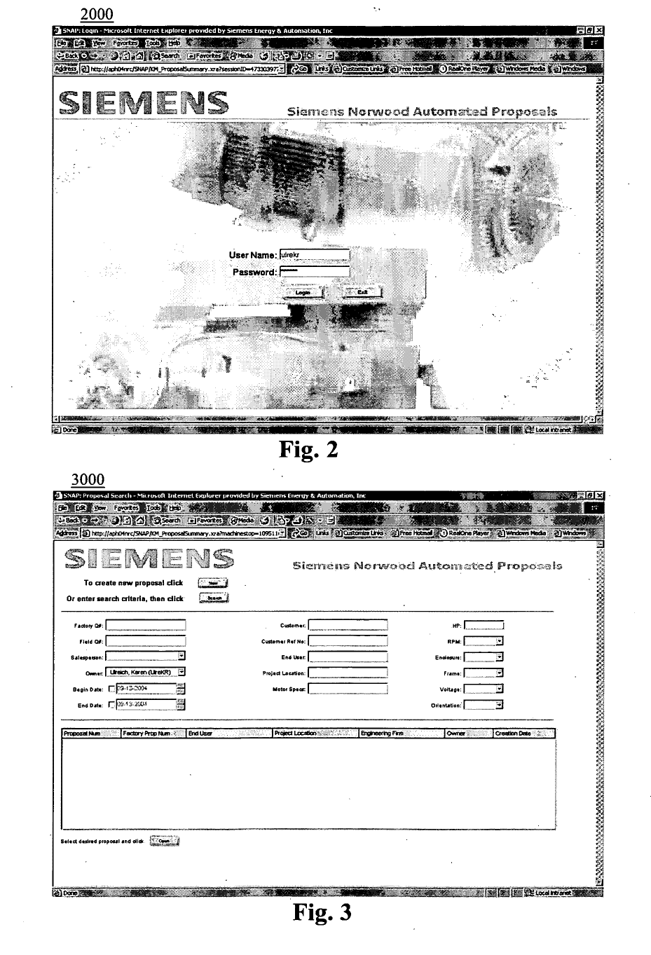

FIG. 2 is a screen shot of an exemplary embodiment of an interface 2000, which can be used for logging on to the SNAP system.

SNAP Proposal Search

FIG. 3 is a screen shot of an exemplary embodiment of an interface 3000, which can be used for initiating the creation of a new proposal or searching for an existing proposal. The owner can default to the user.

Proposal Structure

A proposal can encompass an entire project for an end customer. It can consist of multiple quotations (line items) for different customers that include the end customer themselves, and OEMs and/or distributors supplying equipment to them. This can allow the user to enter comments to the end customer's specifications only once for all line items. The database can be set up with this structure in mind, therefore, the Proposal Summary screen can be considered the central screen from which most actions are initiated.

SNAP Proposal Summary

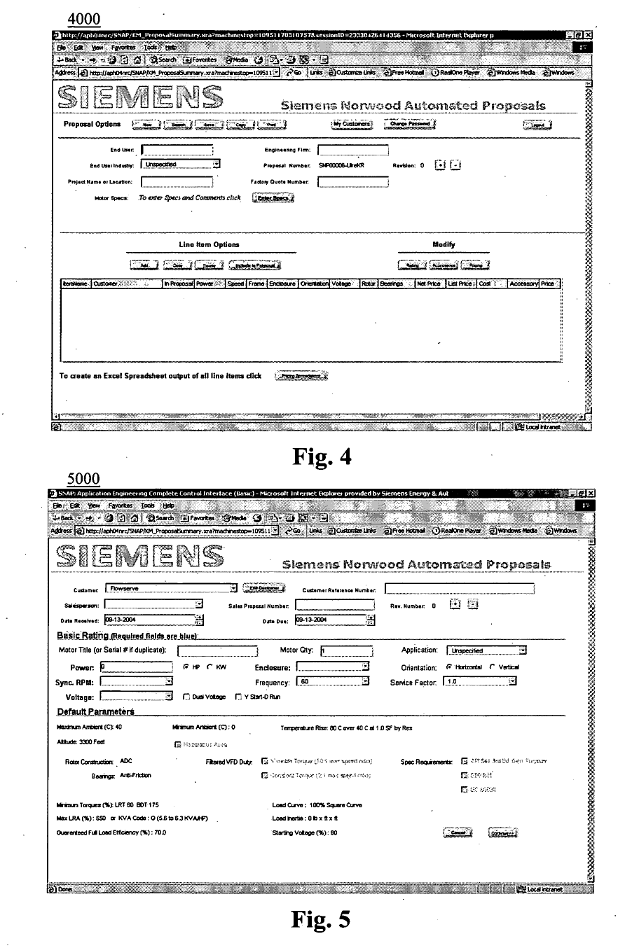

FIG. 4 is a screen shot of an exemplary embodiment of an interface 4000, which can be used for entering, receiving, summarizing, and/or rendering customer information, needs, specifications, and/or requirements.

All fields on this screen can be optional.

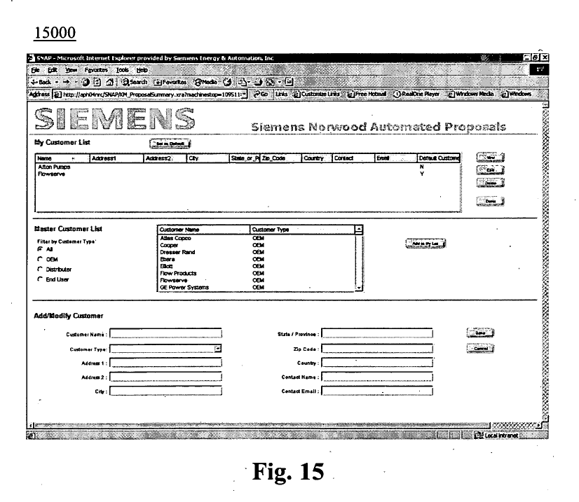

“My Customers” button can access the Customer Maintenance screen (see FIG. 15). This section can be where the user selects customers from a pre-defined list and/or enters a new customer.

Users and Security

There can be 3 types of users: Application Engineer (AE), Inside Sales Support (IS), and Outside Sales (OS). The main differences between these three are who can see which proposals and line items, and who can see costs.

In certain exemplary embodiments, AEs see cost data, although IS and OS can see only list price data. AEs also can see any proposal in the database. OS can see only those to which their name has been assigned as salesperson, including any they have personally created. IS may see any that are tied to their Center of Excellence, so that they may act as back-up for each other. All United States OS can be linked with one of the Centers of Excellence. In addition, there can be generic users that can been created for each CofE so that when the salesperson is not known, the user can at least start the proposal by tying it to the CofE. For this initial phase, there also can be generic users created for Canada, Mexico and/or Europe. These need not be tied to any CofE. Adjustments can be made during Pricing Analysis to reflect the current pricing arrangement with those entities.

SNAP Basic Rating

FIG. 5 is a screen shot of an exemplary embodiment of an interface 5000, which can be used for entering and/or receiving information sufficient to obtain, and/or for rendering, a basic rating of a motor.

In certain exemplary embodiments, the user must specify those fields shown in BLUE:
Salesperson (can defaults to that of previous line item IF a copy).
   The list of Salespersons can include all outside Sales in the US. It also can include generic Sales for each Center of Excellence, as well as Mexico, Canada, and/or Europe.
Power, RPM, Voltage, Enclosure

Customer can default to the user's default customer.

“Edit Customer” button can allow the user to make changes to the customer information that will be saved only for this line item. It need not make changes to the user's permanent customer list. Those changes can be made through the Proposal Summary screen.

SNAP Full and Partial Ratings

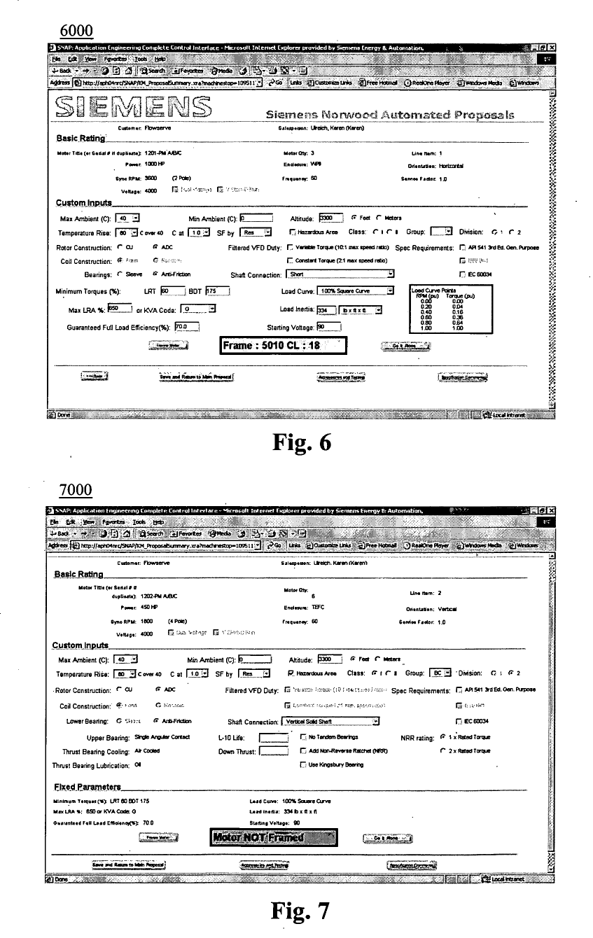

FIG. 6 is a screen shot of an exemplary embodiment of an interface 6000, which can be used for entering and/or receiving information sufficient to obtain, and/or for rendering, a full rating of a motor.

FIG. 7 is a screen shot of an exemplary embodiment of an interface 7000, which can be used for entering and/or receiving information sufficient to obtain, and/or for rendering, a partial rating of a motor.

The “Go It Alone” button can take an AE to the AE Design Interface Screen.

AE Design Interface can open all the fields for input as well as provide a means to generate an Engineering Request form for the design data. (Sales can see “Turn Over to Factory” instead.)

“Back” button can return to the Basic Rating screen to permit changes to the Basic Rating.

Load Curve Inputs

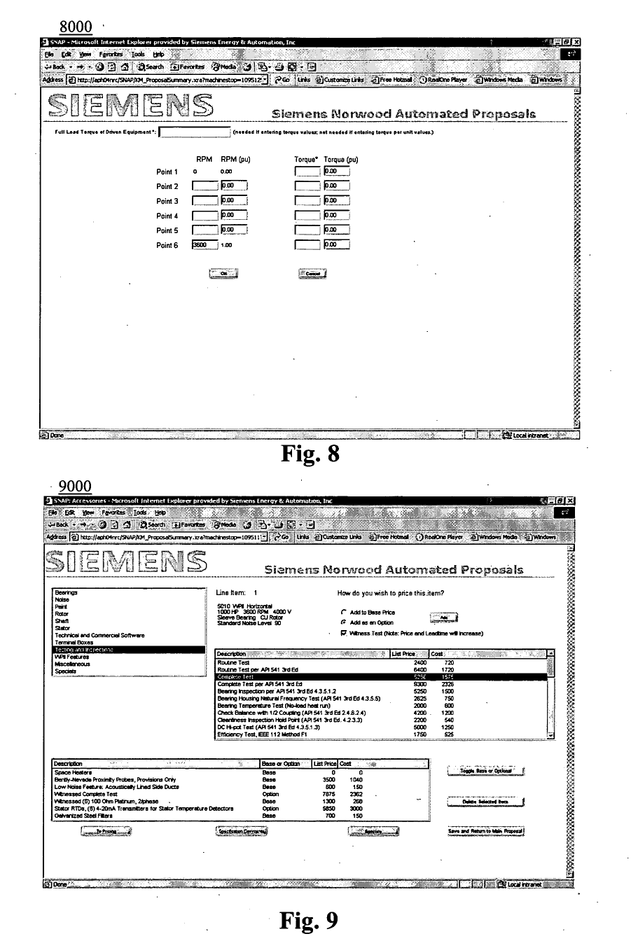

FIG. 8 is a screen shot of an exemplary embodiment of an interface 8000, which can be used for entering, receiving, and/or rendering performance-related information, needs, specifications, and/or requirements. For example, interface 8000 can be used for inputting a desired load curve.

SNAP Accessory and Testing

FIG. 9 is a screen shot of an exemplary embodiment of an interface 9000, which can be used for entering, receiving, and/or rendering optional components, accessories, software, and/or tests.

While nothing on this screen need be required, at a minimum, SNAP can require the user to enter & exit this screen. Doing so can trigger the logic to check to see if any accessories should be removed to compensate for changes in framing that invalidate either the cost of the item or the function of the item (such as filters on a TEFC).

Other background processing that can take place during this time includes:
API 541 or IEEE 841 accessories can be added or deleted, if applicable.
SNAP can check and/or adjust the noise level based on selections.
SNAP can adjust lead times if impacted by the addition of tests.
SNAP can verify terminal box sizing, based on box selected, standard box required, and/or box required for the accessories selected.
   SNAP Pricing Analysis

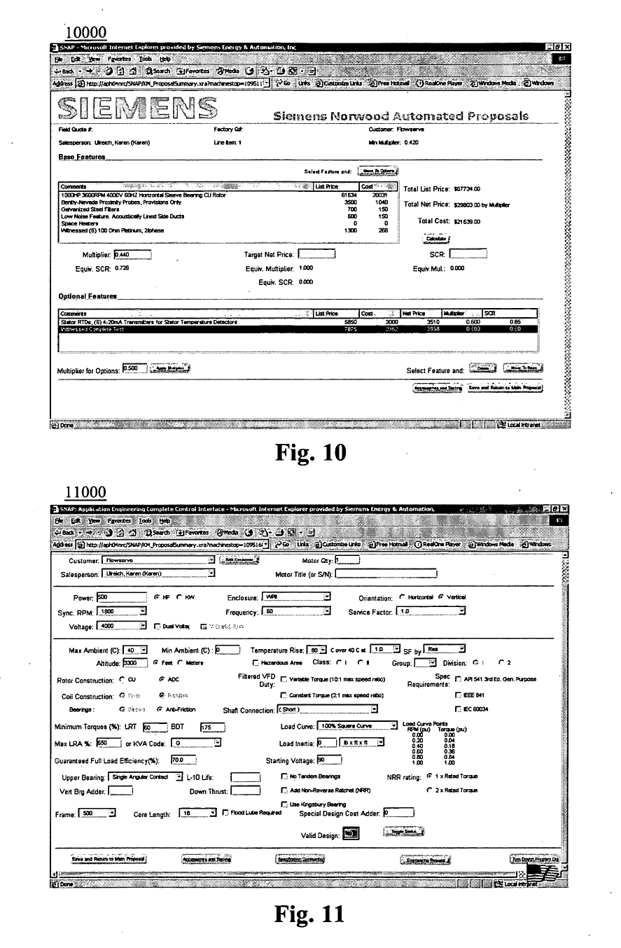

FIG. 10 is a screen shot of an exemplary embodiment of an interface 10000, which can be used for entering, receiving, and/or rendering pricing information, options, and/or analysis. Inside and Outside sales need not see costs, SCRs, or customer's multipliers.

SNAP AE Design Interface

FIG. 11 is a screen shot of an exemplary embodiment of an interface 11000, which can be used for entering, receiving, and/or rendering application engineering design information, data, requests, decisions, and/or analysis.

Special Design Requests

A special design request can come from either the AE or Sales. The AE can select the button to “Go It Alone”. This can open up all data fields for input. The AE can input the relevant data, and then can select the Engineering Request form button, which can automatically create the form.

Salespeople can request that the factory review a design by selecting the “Turn Over to Factory” button. Once they do so, they can lock themselves out of modifications to the rating. It can be their responsibility to notify the factory, either by phone or e-mail, that they have a request pending.

Once notified, the AE can open the proposal to review the information. Again, the AE can generate an Engineering Request form if needed.

When an AE is ready to validate the design, either with or without an Engineering Request, he/she can enter the frame, core length, and/or any cost adder associated with the design, and then can toggle the Design Status to “Yes”. This can tell SNAP that the Salesperson is permitted to proceed to the pricing screen. The AE can be responsible for notifying the Salesperson that they have a valid design.

NOTE: Upon design validation, the AE can also check to see if any Accessories have been selected. This can be indicated by the word ‘valid’ in the Accessory column on the Proposal Summary screen. This is because Sales can enter accessories even after they have submitted a design request. This can be to facilitate the Sales completing as much of the proposal as possible with only minor intervention from the factory. The AE then can run the accessory section only to determine what, if any, accessories need to be updated because of changes to the rating.

SNAP AE Special Accessory Interface

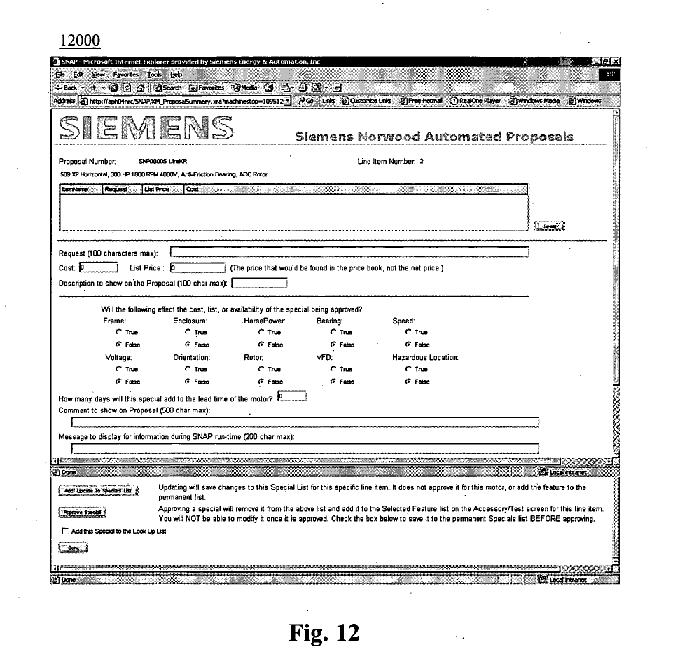

FIG. 12 is a screen shot of an exemplary embodiment of an interface 12000, which can be used for entering, receiving, and/or rendering information, needs, specifications, requirements, data, requests, decisions, and/or analysis regarding special and/or non-standard components, accessories, software, and/or tests.

This screen can be used to input the characteristics for an accessory or test which is not on the standard lists. This can include identifying which features of a motor may impact either the validity and/or price of the accessory. SNAP can use this information to automatically remove accessories to ensure proper pricing and designs are used.

An AE can input the entire Special, or it can be initiated by a Salesperson. They can enter only the Request information and then can notify the factory they have a request pending.

These special items can be saved to a permanent master list for future use on other proposal. Should use of these become frequent, they eventually can be transferred to the regular accessory categories. Until then, only the AEs can have access to the master Specials.

SNAP Comments and Specifications

Comments to Specs

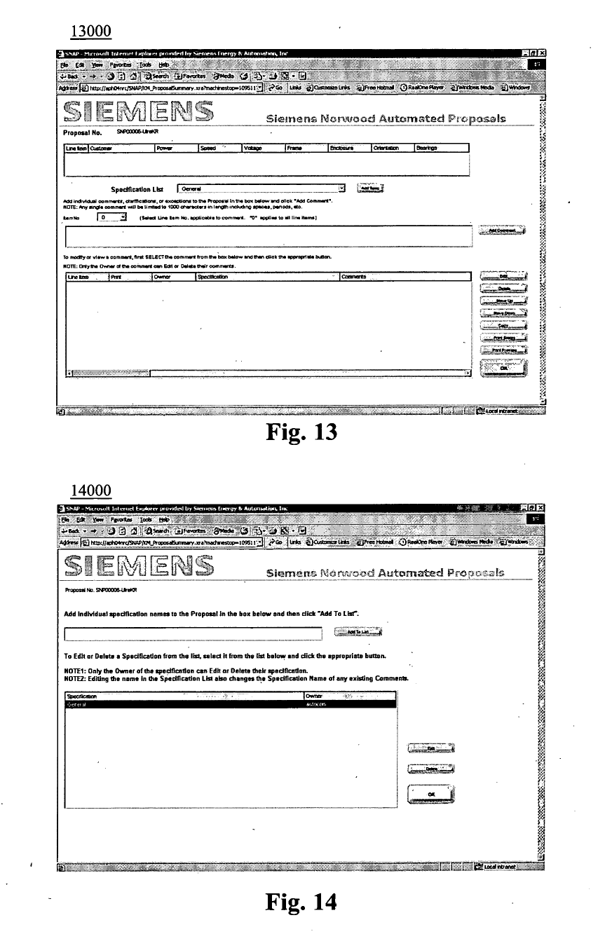

FIG. 13 is a screen shot of an exemplary embodiment of an interface 13000; which can be used for entering, receiving, and/or rendering information, comments, clarifications, and/or exceptions regarding proposed components, accessories, software, and/or tests.

Specifications

FIG. 14 is a screen shot of an exemplary embodiment of an interface 14000, which can be used for entering, receiving, and/or rendering information regarding specifications.

Comments can be entered from the Proposal Summary, the Rating, the Accessory/Test, and/or the Pricing Screens. Specifications can be entered from the Comments.

“General” can be present as a “specification”. Any automatic comments generated by SNAP can fall into this category.

A user can view all comments and specifications for a proposal on these screens. A user can be limited to only deleting or modifying those comments and/or specifications that the user has created.

SNAP Customer Maintenance

FIG. 15 is a screen shot of an exemplary embodiment of an interface 15000, which can be used for entering, receiving, and/or rendering information regarding customers.

This screen can be accessed via the Proposal Summary Screen. A customer from the Master List can have an established minimum multiplier. A user can customize the address for that customer, while keeping the multiplier. A customer not from the master list can be assigned a higher minimum multiplier to protect alliances/partners. The first customer a user selects can automatically become the user's default customer, although the user can change this by selecting a customer in “My Customer List” and clicking “Set as Default”.

Customer Lists

Each user can custom design their Customer list by selecting a customer name from a master list or entering a new customer name. The master list can comprise customers for which certain pricing levels have been established. New customers can be given higher levels to protect established relationships with existing customers. Customers on the master list can be assigned a level based upon whether they are an alliance partner, key distributor or OEM, or a known customer, but at a level between the strategic customers and brand-new ones.

The master list can enable SNAP to use the same pricing constraints for a given customer, while allowing different sales personnel to use different addresses for that same customer (i.e., a customer company can have offices on both the East and West coast, but receive the same pricing levels).

Once a customer has been selected, a user can add as much or as little detail as desired. The first customer a user selects can become that user's default customer. This default can be changed on the Customer Maintenance Screen whenever necessary.

When one user accesses a line item created by another, he/she can be limited to modifying the customer information for that line only. This can allow a salesperson to include address information on a line item created by the factory who might not have had (or wanted) that info.

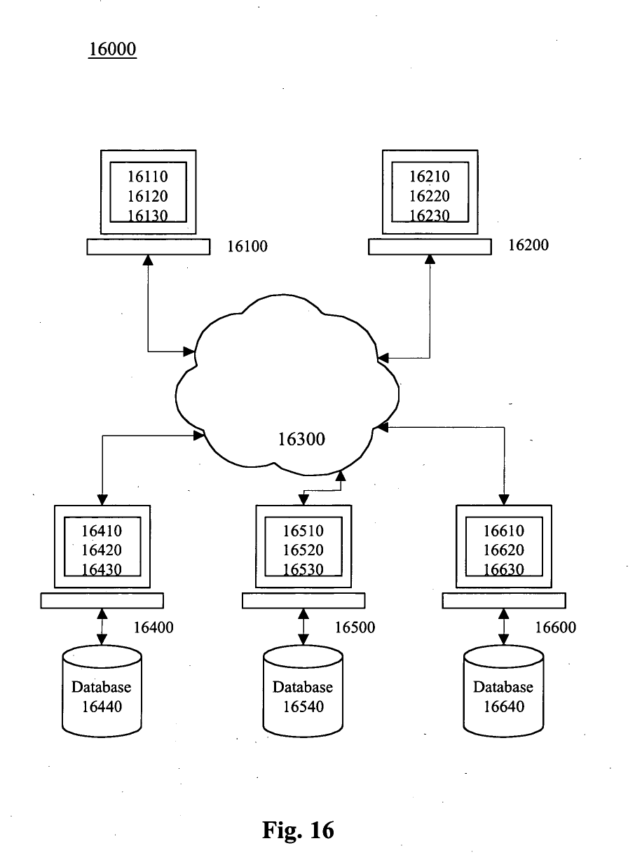

FIG. 16 is a block diagram of an exemplary embodiment of a system 16000, which can comprise an inside salesperson information device 16100 and/or an outside salesperson information device 16200, either of which can be coupled to a network 16300, to which can be coupled an application engineer information device 16400, a factory information device 16500, and/or a server 16600.

Inside salesperson information device 16100 can comprise a display 16110 via which a web browser 16120 can render one or more user interface screens 16130. Outside salesperson information device 16200 can comprise a display 16210 via which a web browser 16220 can render one or more user interface screens 16230. Application engineer information device 16400 can comprise a display 16410 via which a web browser 16420 can render one or more user interface screens 16430. Coupled to application engineer information device 16400 can be a database 16440. Factory information device 16500 can comprise a display 16510 via which a web browser 16520 can render one or more user interface screens 16530. Coupled to factory information device 16500 can be a database 16540. Server 16600 can comprise a display 16610 via which a web browser 16620 can render one or more user interface screens 16630, which can be useful for administering server 16600. Coupled to server 16600 can be a database 16640.

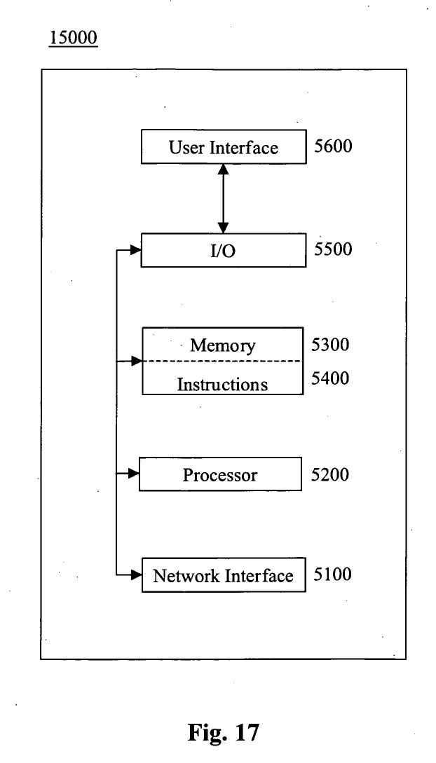

FIG. 17 is a block diagram of an exemplary embodiment of an information device 17000, which in certain operative embodiments can comprise, for example, inside salesperson information device 16100, outside salesperson information device 16200, application engineer information device 16400, factory information device 16500, and/or server 16600 of FIG. 16. Information device 17000 can comprise any of numerous components, such as for example, one or more network interfaces 17100, one or more processors 17200, one or more memories 17300 containing instructions 17400, one or more input/output (I/O) devices 17500, and/or one or more user interfaces 17600 coupled to I/O device 17500, etc.

In certain exemplary embodiments, via one or more user interfaces 17600, such as a graphical user interface, a user can view a rendering of information related to specifying, ordering, designing, selling, manufacturing, and/or delivering a product such as an electric motor.

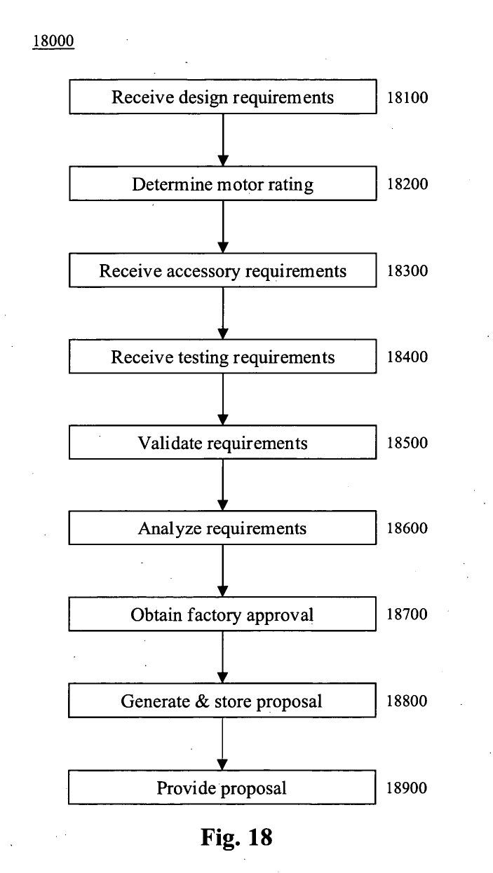

FIG. 18 is a flowchart of an exemplary embodiment of a method 18000, any activity of which can be performed by an information device and/or server of FIG. 16. At activity 18100, design requirements can be received. At activity 18200, a motor rating can be automatically determined. At activity 18300, accessory requirements can be received. At activity 18400, testing requirements can be received. At activity 18500, requirements can be automatically validated. At activity 18600, requirements can be automatically analyzed. At activity 18700, factory approval can be obtained. At activity 18800, a proposal can be automatically generated, modified, and/or stored. At activity 18900, a proposal can be automatically transmitted, provided, and/or rendered.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, such as via an explicit definition, there is no requirement for the inclusion in any claim herein (or of any claim of any application claiming priority hereto) of any particular described or illustrated characteristic, function, activity, or element, any particular sequence of activities, or any particular interrelationship of elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A system for developing a proposal for an above-NEMA squirrel cage induction motor, comprising:
at least one processor adapted to:
receive customer design requirements;
determine a rating of the motor based upon the customer design requirements;
receive accessory requirements;
receive testing requirements; and
automatically generate a proposal for the motor based upon an analysis of the customer design requirements, accessory requirements, and testing requirements.

2. The system of claim 1, wherein:
said at least one processor is adapted to receive at least one of the customer design requirements, the accessory requirements, and the testing requirements via a real-time ActiveX COM interface.

3. The system of claim 1, wherein:
said at least one processor is adapted to validate at least one of the customer design requirements, accessory requirements, and testing requirements.

4. The system of claim 1, wherein:
said at least one processor is adapted to receive modifications to at least one of the customer design requirements, accessory requirements, and testing requirements.

5. The system of claim 1, wherein:
said at least one processor is adapted to identify any of the customer design requirements, accessory requirements, and testing requirements that require factory approval.

6. The system of claim 1, wherein:
said at least one processor is adapted to submit for factory approval any of the customer design requirements, accessory requirements, and testing requirements that require factory approval.

7. The system of claim 1, wherein:
said at least one processor is adapted to analyze the customer design requirements, accessory requirements, and testing requirements.

8. The system of claim 1, wherein:
said at least one processor is adapted to analyze the customer design requirements, accessory requirements, testing requirements, and cost information.

9. The system of claim 1, wherein:
said at least one processor is adapted to provide secure access to cost information.

10. The system of claim 1, wherein:
said at least one processor is adapted to adjust a price comprised by the proposal.

11. The system of claim 1, wherein:
said at least one processor is adapted to store the proposal.

12. The system of claim 1, wherein:
said at least one processor is adapted to provide secure access to any of a plurality of stored proposals.

13. The system of claim 1, wherein:
said at least one processor is adapted to search for the proposal.

14. The system of claim 1, wherein:
said at least one processor is adapted to provide the proposal to a customer.

15. The system of claim 1, wherein:
said at least one processor is adapted to obtain electrical data associated with the motor.

16. The system of claim 1, wherein:
said at least one processor is adapted to obtain an engineering drawing for the motor.

17. The system of claim 1, wherein:
said at least one processor is adapted to obtain a performance curve for the motor.

18. The system of claim 1, wherein:
said at least one processor is adapted to, for the motor, provide at least one of electrical data, an engineering drawing, and a performance curve with the proposal.

19. The system of claim 1, wherein:
the proposal comprises one or more accessories that comply with the accessory requirements.

20. A system for developing a proposal for an above-NEMA squirrel cage induction motor, comprising:
at least one interface adapted to:
receive customer design requirements;
determine a rating of the motor based upon the customer design requirements;
receive accessory requirements;
receive testing requirements; and
automatically generate a proposal for the motor based upon an analysis of the customer design requirements, accessory requirements, and testing requirements.

21. A system for developing a proposal for an above-NEMA squirrel cage induction motor, comprising:
at least one graphical user interface adapted to:
receive customer design requirements;
determine a rating of the motor based upon the customer design requirements;
receive accessory requirements;
receive testing requirements; and
automatically generate a proposal for the motor based upon an analysis of the customer design requirements, accessory requirements, and testing requirements.
